(19) United States
(12) Patent Application Publication
(10) Pub. No.: US 2007/0086384 A1
(43) Pub. Date: Apr. 19, 2007

(54) Method of setting up quality of service in wireless communication network and wireless communication apparatus

(76) Inventors: Yuichiro Katsu, Yokohama (JP); Akio Kawase, Fujisawa (JP); Shingo Sasaki, Yokohama (JP); Hideo Aoe, Yokohama (JP)

Correspondence Address: MCDERMOTT WILL & EMERY LLP, 600 13TH STREET, N.W., WASHINGTON, DC, 20005-3096, US

(21) Appl. No.: 11/516,056

(22) Filed: Sep. 6, 2006

(30) Foreign Application Priority Data
Sep. 6, 2005 (JP) 2005-257458

(51) Int. Cl. H04Q 7/00

(52) U.S. Cl. 370/331

(57) ABSTRACT

A wireless communication apparatus for communicating with a base station is provided with the function of specifying the type of an application from header information of an IP packet issued by the application, searching for a set of radio parameters for assuring a Quality of Service (QoS) required by the application from a conversion table having been prepared beforehand, and automatically setting up a new session based on the set of radio parameters.

### CLAIM OF PRIORITY

The present application claims priority from Japanese application serial No. 2005-257458, filed on Sep. 6, 2005, the content of which is hereby incorporated by reference into this application.

### BACKGROUND OF THE INVENTION

1. Field of the Invention

The present invention relates to a method of setting up a Quality of Service in a wireless communication network and a wireless communication apparatus.

2. Description of Related Art

In a wireless communication network, full-fledged data communication is lately becoming widely used and a variety of services such as stream video and VoIP are provided. To provide communication services with a high regard for quality of communication such as real-time operability and delay in wireless communication network, it is needed to assure a Quality of Service (hereinafter referred to as QoS).

3GPP2 C.R1001-Draft (Non-Patent Document 1), CS0024-A (Non-Patent Document 2), and X.P0011-4 (Non-Patent Document 3) which relate to standards for mobile communication networks describe a method of assigning resources of a network comprising a base station (base transmission subsystems: BTS), a base station controller (BSC), and a gateway (GW) connected to a public network or the Internet, based on QoS information that is exchanged between a mobile terminal and an Authentication, Authorization and Accounting (AAA) station.

Further, for example, Published Japanese Translation of PCT International Publication for Patent Application No. 2003-509983 (WO 01/020946: Patent Document 1) has proposed a method and apparatus for setting up a QoS depending on an application to be executed on a mobile terminal in a mobile communication network.

FIG. 14 shows the protocol stacks and software structures present on a mobile terminal MT and terminal equipment TE connected to the MT proposed in the above Patent Document 1 for QoS setup adaptive for applications. Here, a QoS application 550 operating in the application layer over the UDP layer 540 of the terminal equipment TE interfaces with an object resource broker (ORB) 560 operating in the application layer over the UDP layer 570 of the mobile terminal MT. The ORB 560 interfaces with an enhanced radio access network application (ERANAP) unit for Enhanced General Packet Radio Service (EGPRS).

QoS information required for a voice application 510, a data application 520, and a multimedia application 530 to be executed in the application layer over the UDP layer 540 of the terminal equipment TE is notified to the ERANAP 580 via the QoS application 550 and ORB 560. The ERANAP 580 converts the QoS information into an EGPRS parameter request to be transmitted onto a radio access network (RAN) for EGPRS. According to Patent Document 1, however, the QoS information required for the applications 510-530 is specified manually by the user of the terminal equipment TE through a user interface.

In a mobile communication network adopting a protocol prescribed in the above Non-Patent Documents 1, 2, and 3, QoS can be controlled by cooperation between a mobile terminal, BTC, BSC, and GW. However, these documents provide no specification about applications to be executed on terminal equipment, for example, a personal computer (PC) connected to a mobile terminal. Thus, each PC has to be equipped with a special application for connecting to a mobile terminal, and when one application being run on the PC in cooperation with the above special application, for example, it would become impossible to make other applications cooperate with the special application.

In Patent Document 1, the terminal user is required to specify a QoS in advance of the execution of an application. Accordingly, for example, as illustrated in FIG. 15, a connection request designating a QoS has to be first issued from the special application 32 (corresponding to the QoS application 550 mentioned in FIG. 14) operating on the terminal equipment to the ORB 560 of the associated mobile station (MT) 50 (SQ10) and the mobile station 50 sets radio parameters in response to the above connection request (SQ11). Then, a QoS setting procedure (SQ12, SQ13) must be performed between the mobile station 50, the associated base station (BTS) 10 (and base station controller BSC 11), and the gateway (GW) 12.

In this case, upon completion of the QoS setting procedure, a connection complete notification is sent from the mobile station 50 to the terminal equipment (SQ14). After receiving the connection complete notification, the active application 31 transmits an IP packet (data request) addressed to a server 13 (SQ21) and receives desired data from the server (SQ22). Patent Document 1 has no disclosure regarding QoS control when making parallel connection of a plurality of applications to the radio access network (RAN).

### SUMMARY OF THE INVENTION

It is an object of the invention is to provide a method of setting up a QoS in a wireless communication network and a wireless communication apparatus, adapted to enable automatic setting of a QoS required for any application to be executed on the wireless communication apparatus (mobile terminal) or any application to be executed on terminal equipment connected to the wireless communication apparatus.

It is another object of the invention is to provide a method of setting up a QoS in a wireless communication network and a wireless communication apparatus, adapted to enable assuring a QoS suitable for each application on a radio access network (RAN) without altering the function of individual application and the function of terminal equipment connected to the wireless communication apparatus.

It is a further object of the invention is to provide a method of setting up a QoS in a wireless communication network and a wireless communication apparatus, adapted to enable concurrently assuring QoS levels for a plurality of applications to be executed in parallel.

To achieve the above objects, in the present invention, a wireless communication apparatus (wireless terminal) communicating with a base station specifies the type of the application from header information of an IP packet issued by an application, searches for a set of radio parameters for assuring a Quality of Service (QoS) required by the application from a conversion table having been prepared beforehand, and automatically setup a new session based on the set of radio parameters.

More specifically, a wireless communication apparatus according to the present invention is comprised of a conversion table including a plurality of entries, each defining a set of radio parameters for assuring a Quality of Service (QoS) in association with the value of at least one header item of an IP packet, and a controller for searching the conversion table based on header information of an IP packet issued from an application, for a set of radio parameters appropriate to the received packet, and executing a specific communication procedure for setting up a new session between the apparatus and its associated base station based on the set of radio parameters, wherein a QoS required by the application is assured on the session.

The conversion table may be divided into, for example, a QoS type table including a plurality of entries, each defining a QoS type number in association with the value of at least one header item of an IP packet, and a radio parameter table including a plurality of entries, each defining a set of radio parameters for assuring a QoS in association with the QoS type number. The application may be executed on another terminal equipment independent from the wireless communication apparatus.

According to the present invention, a method of setting up a Quality of Service in a wireless communication network including a wireless communication apparatus and wireless base stations connected to the Internet network via a base station controller is comprises of:

a step of searching a conversion table having been prepared beforehand, by the wireless communication apparatus based on header information of an IP packet issued from an application, for a set of radio parameters for assuring a Quality of Service (QoS) appropriate to the received packet; and

a step of executing a specific communication procedure for setting up a new session between the wireless communication apparatus and its associated base station based on the set of radio parameters searched from the conversion table.

According to the present invention, it is possible to automatically assure a QoS required by each application being executed without QoS specification by the terminal user. Even if a plurality of applications are executed in parallel, a QoS for each application can be assured.

### BRIEF DESCRIPTION OF THE DRAWINGS

FIG. 1 shows an example of a wireless communication network to which the invention is applied.

FIGS. 2A and 2B show alternative examples of relationship between a wireless communication terminal of the present invention and applications.

FIG. 3 shows a conceptual diagram of setting QoS levels in a radio section between the wireless communication apparatus and BTS.

FIG. 4 is a communication sequence diagram illustrating the QoS setup method according to the present invention.

FIG. 5 is a block structural diagram illustrating an embodiment of the wireless communication apparatus that realizes QoS setup according to the present invention.

FIG. 6 is a block structural diagram illustrating an embodiment of terminal equipment connected to the wireless communication apparatus (AT).

FIG. 7 shows an example of a QoS type table provided in the wireless communication apparatus (AT) of the present invention.

FIG. 8 shows an example of a radio parameter table provided in the wireless communication apparatus (AT) of the present invention.

FIG. 9 is a flowchart illustrating an embodiment of a QoS processing routine to be executed on the wireless communication apparatus (AT) of the present invention.

FIGS. 10A and 10B show a relationship between an IP packet and an RLP packet.

FIG. 11 shows a forwarding process of a transmission IP packet after issued by an application until reaches the transceiver FIG. 12 shows an example of end-to-end communication sequence in the wireless communication network to which the invention is applied.

FIG. 13 shows another example of end-to-end communication sequence in the wireless communication network to which the invention is applied.

FIG. 14 shows an example of software structure according to prior art for QoS setup adaptive to applications.

FIG. 15 shows a communication sequence for QoS setup according to prior art.

### DETAILED DESCRIPTION OF PREFERRED EMBODIMENTS

Embodiments of the present invention will be described hereinafter with reference to the drawings.

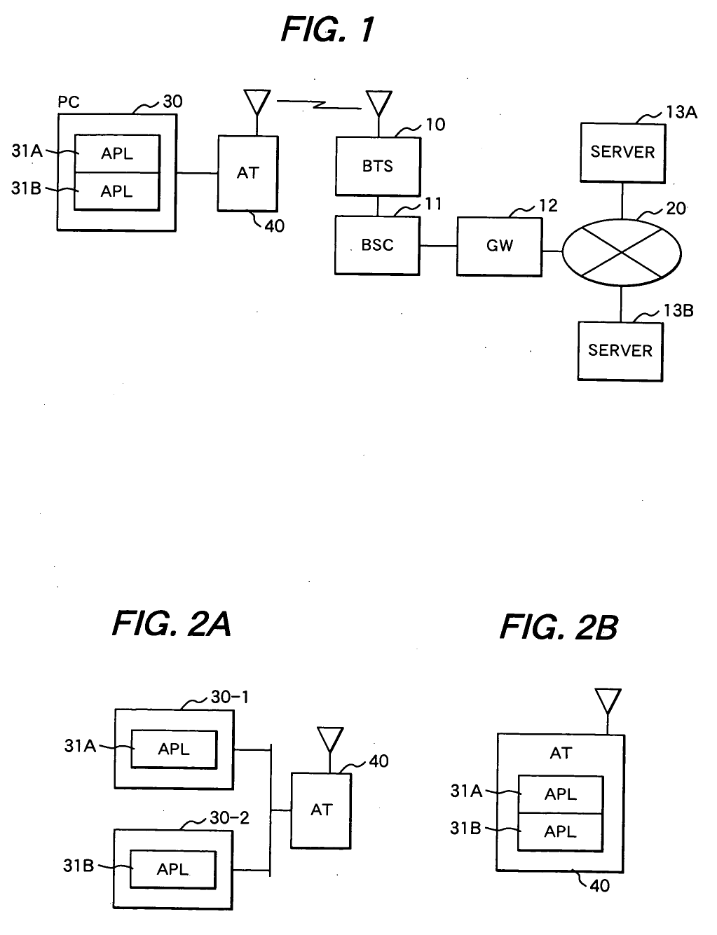

FIG. 1 shows an example of a wireless communication network to which the invention is applied.

The wireless communication network shown here comprises a wireless terminal (Access Terminal: AT) 40, a wireless base station (Base-station Transceiver Subsystem: BTS) 10, a base station controller (BSC) 11 connected to the BTS 10, and a gateway (GW) 12 for connecting the BSC 11 to an external communication network, e.g., an Internet network 20.

To the Internet network 20, a plurality of servers 13 (13A, 13B, etc.) are connected. Although only a single BTS 10 is shown in FIG. 1, a plurality of BTS stations are connected to the BSC 11 in an actual wireless communication network. A multiplicity of wireless terminals, which are omitted in FIG. 1, may be connected to each BTS. To the Internet network 20, many GWs other than the GW 12 may be connected and further RANs or LANs may be connected via these GWs.

To the AT 40, terminal equipment for executing application programs (hereinafter referred to as simply applications) 31 (31A, 31B, etc.), for example, a personal computer (PC) 30 is connected. The PC 30 and the AT 40 may be connected via, for example, a general Local Area Network (LAN), Universal Serial Bus (USB), or an infrared/serial interface.

The terminal user communicates with an server 13 or another terminal equipment on the Internet network 20 by executing an application 31 on its terminal equipment 30. A feature of the present invention resides in that the AT 40 has capability of automatically setting up a QoS appropriate to the application 31 upon receiving a packet passed from the application 31, without requiring the terminal user to specify QoS information.

The wireless communication apparatus (AT) 40 of the present invention may have connections with plural pieces of terminal equipment (PCs) 30-1 and 30-2, for example, as illustrated in FIG. 2A. In this case, the AT 40 automatically sets up QoS levels optimum for applications 31A, 31B, respectively, which are executed in parallel on the terminal equipment 30-1 and 30-2. The wireless communication apparatus (AT) 40 of the present invention can automatically set up QoS levels for applications 31A and 31B to be executed on the AT 40, in a similar manner, for example, as illustrated in FIG. 2B.

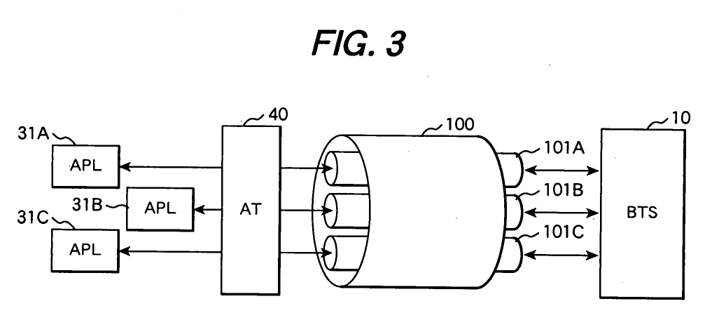

FIG. 3 shows a conceptual diagram of setting up QoS levels in a radio section between the wireless communication apparatus (AT) 40 and the BTS 10.

In the radio section between the AT 40 and the BTS 10, a radio channel 100 with a predetermined communication bandwidth BWmax is formed. On the radio channel 100, a plurality of logical sessions (101A, 101B, 10c, etc.) having individual QoS levels are multiplexed. The number of sessions that can be multiplexed on a single radio channel 100 is prescribed by a 3GPP2 standard. For each of the sessions multiplexed on the radio channel 100, an individual QoS level can be set, unless a total of QoS bandwidths does not exceed the communication bandwidth BWmax.

Packets passed from the applications 31 (31A, 31B, 31C, etc.) to the AT 40 are transmitted from the AT 30 to the BST 10 through the appropriate sessions with QoS levels adaptive for each application. Thereby, it is possible to ensure, on the radio channel, QoS levels different depending on application type, such as File Transport Protocol (FTP), Voice over Internet Protocol (VoIP), and Stream Data.

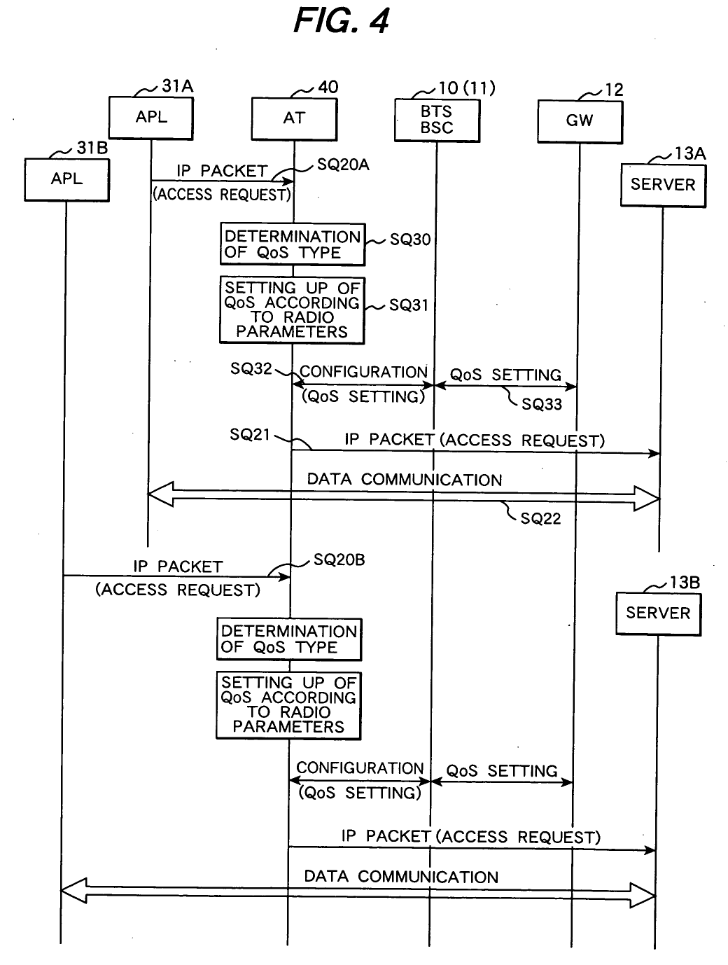

FIG. 4 is a communication sequence diagram illustrating the QoS setup method according to the present invention in the wireless communication network shown in FIG. 1.

For instance, suppose that an IP packet for a server access request has now been issued from an application (APL) 31A (SQ20A). In the present invention, the AT 40 having received the IP packet determines a QoS type suitable for the APL 31A based on the header information of the received packet and a QoS type table which will be described later (SQ30). The AT 40 searches for a radio parameter set corresponding to the above QoS type from a radio parameter table which will be described later and begins QoS setup according to the retrieved radio parameter set (SQ31). The QoS setup is achieved by exchanging control messages between the AT 40 and its associated BTS 10 (and BSC 11) in accordance with a Session Configuration Protocol and other protocols, such as Protocol Negotiation and Protocol Configuration, specified in Non-Patent Documents 2 and 3 (SQ32), and performing a predetermined QoS setup procedure (SQ33) between the BSC 11 and GW 12.

Upon completion of the QoS setup, the AT 40 transmits the packet (server access request) having been received from the APL 31A and waiting for transmission to the BTS 10 (SQ 21). The packet received at the BTS 10 is sent out to the internet 20 via the BSC 11 and GW 12 and forwarded to the destination server 13A according to the destination IP address. Then, QoS-assured data communication is commenced between the APL 31A and the server 13A (SQ22).

When an IP packet (server access request) is issued from another application (APL) 31B (SQ20B), the AT 40 performs the same operation steps (SQ30-SQ32, SQ21) as described above when having received the IP packet from the APL 31A, thereby automatically setting up a session with a QoS that is optimum for the APL 31B.

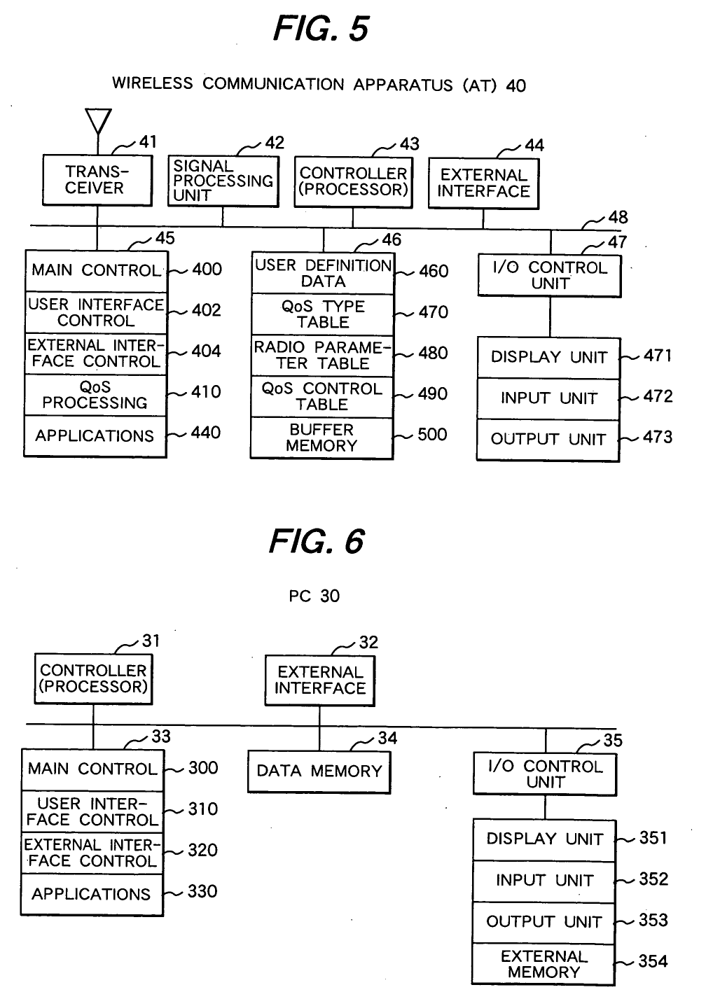

FIG. 5 is a block structural diagram illustrating an embodiment of the wireless communication apparatus (wireless terminal AT) that realizes automatic QoS setup according to the present invention.

The AT 40 comprises a transceiver 41 equipped with an antenna for wireless communication with BTS 10, a signal processing unit 42, a controller (processor) 43, an external interface 44 for connecting to PC 30, a program memory 45, a data memory 46, and an I/O control unit 47. These components are connected by an internal bus 48. To the I/O control unit 47, for example, a display unit 471, an input unit 472 including a set of input buttons, a microphone, etc., and an output unit 473 such as a speaker are connected.

In the program memory 45, as programs to be executed by the controller (processor) 43, a main control routine 400, a user interface control routine 402 for controlling data output to the display 471, an external interface control routine 404 for controlling data exchange with the PC 30 via the external interface 44, a QoS processing routine 410 which will be detailed later, and various application programs 440 are installed. Here, the main control routine 400 is provided with an overall control function to selectively activate any of other routines 402, 404, 410, 440 according to user action and a call control function required when carrying out VoIP.

In the data memory 46, user definition data 460, conversion tables for use in QoS setup including a QoS type table 470 and a radio parameter table 480, and a QoS control table 490 are installed. Further, a buffer memory space 500 in which a plurality of queues by QoS type are created is allocated in the data memory 46.

FIG. 6 is a block structural diagram illustrating an embodiment of the terminal equipment (PC) 30 connected to the AT 40.

The PC 30 comprises a controller (processor) 31, an external interface 32 for connecting to the wireless communication apparatus (AT) 40, a program memory 33, a data memory 34, and an I/O control unit 35. These components are connected by an internal bus. To the I/O control unit 35, for example, a display unit 351, an input unit 352 including a set of input keys, a mouse, etc., an output unit 353 such as a printer, and an external memory 354 of a relatively large capacity which serves as an auxiliary memory are connected.

In the program memory 33, as programs to be executed by the controller (processor) 31, a main control routine 300, a user interface control routine 310 for controlling data output to the display unit 351, an external interface control routine 320 for controlling data exchange with the AT 40 via the external interface 44, and various application programs 330 are installed. The APLs 31A and 31B as mentioned in FIG. 1 are prepared as some of the application programs 330.

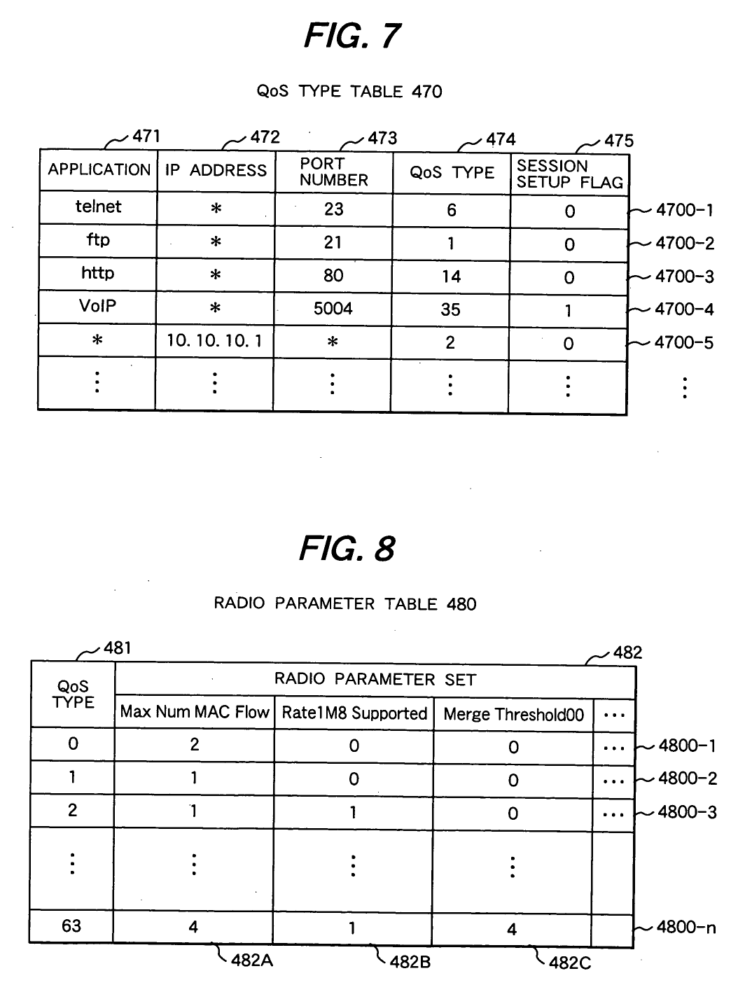

FIG. 7 shows an example of the QoS type table 470.

The QoS type table 470 comprises a plurality of entries 4700-1, 4700-2, etc., each corresponding to application type 471.

Each entry specifies a QoS type (QoS identifier number) 474 specific to the application type and a session setup flag 475. An IP address 472 and a TCP/UDP port number 473 are included as information to identify the application type. The session setup flag 475 indicates whether a session appropriate to the QoS type 474 has been assured, that is, whether or not a session with a radio parameter set appropriate to the QoS type 474 has been set up.

The above QoS type table 470 is referred to in a search for a QoS type (QoS identifier number) 474 and a session setup flag 475, based on a search key of the destination IP address and the destination port number extracted from the header of a received packet. Here, an asterisk (*) mark denotes a “don't care” value in the marked field. A QoS type may be determined only by a port number 473 value, as is shown for entries 4700-1 to 4700-4, or determined only by a destination IP address value 472, as is shown for an entry 4700-5. The latter corresponds to the case where a server with the destination IP address 472 provides an information service with a specific QoS.

FIG. 8 shows an example of the radio parameter table 480.

The radio parameter table 480 comprises a plurality of entries 4800-1 to 4800-n, each defining the correspondence of a QoS type (QoS identifier number) 481 with a set of radio parameters 482. Each radio parameter set 482 is comprised of a plurality of parameter values (482A, 482B, 482C, etc.) such as, for example, Max Num MAC Flows Rate 1M8 Supported, as prescribed in Non-Patent Document 2.

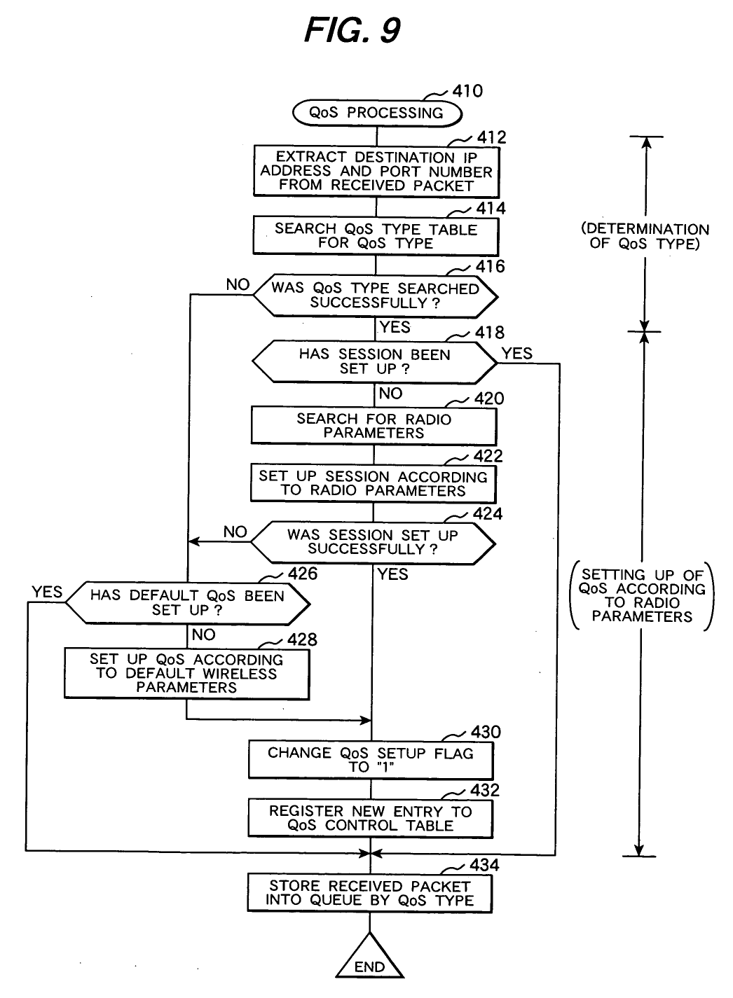

FIG. 9 shows an example of a flowchart of the QoS processing routine 410 to be executed by the controller (processor) 43 of the wireless terminal (AT) 40. The QoS processing routine 410 is executed when the terminal receives an IP packet for an access request from any application 30.

After starting the QoS processing routine 410, the controller 43 first extracts the destination IP address and the destination port number from the IP header and the TCP/UDP header of the received packet (step 412) and searches the QoS type table 470 for a QoS type 474 and a session setup flag 475 corresponding to the above destination IP address and destination port number (414).

Depending on the search result (416), if the QoS type 474 has been found successfully, the controller 43 judges whether a session for the above QoS type has been set up based on the state of the session setup flag 475 (418). If the session has been set up, the controller 43 stores the received packet into a queue by QoS type prepared in the buffer memory 500 according to the QoS control table 490 (434) and terminates this routine.

If the session has not been set up, the controller 43 searches the radio parameter table 480 for a set of radio parameters 482 corresponding to the above QoS type 474 (420) and sets up a session according to the retrieved set of radio parameters (422). The session setup means to establish a new session appropriate to the QoS type by carrying out a specific communication procedure according to the Session Configuration Protocol and other protocols between the terminal and the BTS 10 under the control of the main control routine 400. At this time, a negotiation with regard to the radio parameters is performed between the BTS and its BSC and a flow number is assigned as information to identify the IP packet QoS and the application.

Depending on the result of the session setup (424), if the session appropriate to the QoS type has been set up successfully, the controller 43 changes the value of the session setup flag 475 to the setup done state (“1”) in the QoS type table 470 (430). Then, the controller 43 registers a new control entry into the QoS control table 490 (432) in order to perform QoS control on received packets corresponding to the above QoS type (flow number), stores the received packet into the queue by QoS (434) and terminates this routine.

In the case of an unsuccessful search for QoS type, as judged at step 416, or in the case of an unsuccessful session setup, as judged at step 424, the controller 43 judges whether a session of a default QoS has been set up (426) by referring to a session setup flag in an entry for default QoS registered in the QoS type table 470. If the session of a default QoS has been set up, the controller 43 stores the received packet into a queue for default QoS (434) and terminates this routine. If the session of a default QoS has not been setup, the controller 43 sets up a new session appropriate to QoS type according to a set of radio parameters for a default QoS prepared in the radio parameter table 490 (428) in a similar way as in step 422 and executes step 430.

In the flowchart shown in FIG. 9, steps 412 to 416 correspond to SQ30 of determining a QoS type in FIG. 4 and steps 418 to 432 correspond to SQ31 of setting up a QoS according to a radio parameter set in FIG. 4. An IP packet issued by each application 30 is divided into multiple blocks in accordance with a Radio Link Protocol (RLP) which is a standard protocol and these blocks are converted into RLP packets. Then, the RLP packets are transmitted onto the radio section.

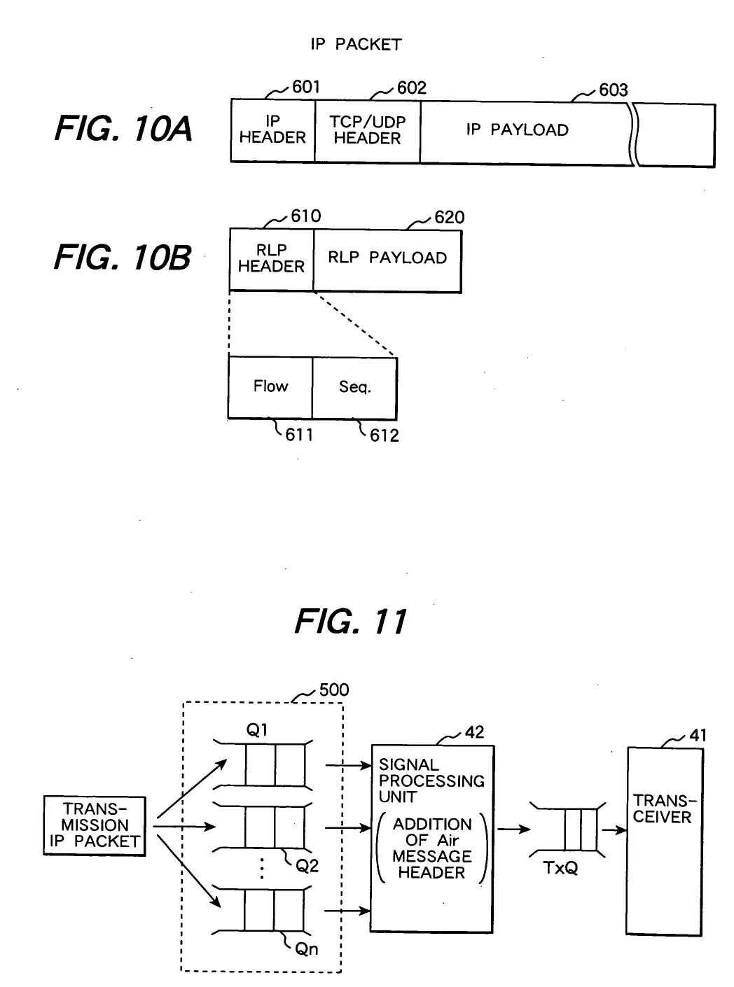

FIGS. 10A and 10B show a relationship between an IP packet and an RLP packet.

As shown in FIG. 10A, an IP packet is comprised of an IP header 601, a TCP/UDP header 602, and an IP payload 603. On the other hand, as shown in FIG. 10B, an RLP packet is comprised of an RLP header 610 including a flow number 611 and a sequence number 612 and an RLP payload 620. The RLP payload 620 carries the contents of one of the multiple blocks into which an IP packet was divided. However, a MAC layer header is further added to an RLP packet that is actually communicated between an AT 40 and a BST 10.

FIG. 11 shows a forwarding process of a transmission IP packet after issued by an application 30 until reaches the transceiver 41.

The transmission IP packet is stored into the appropriate queue by QoS type in the buffer memory space 500 through the QoS processing routine 410. After that, the transmission IP packet is read out by the signal processing unit 42 according to a priority control algorithm corresponding to the QoS. The signal processing unit 42 divides the IP packet into multiple blocks and outputs them to a transmission queue TxQ in the form of the RLP packets as described in FIG. 10 after adding MAC headers. The MAC packets stored in the transmission queue TxQ are read out by the transceiver 41 in a FIFO manner and transmitted onto the radio section. MAC packets from the BTS 10 received by the transceiver 41 are enqueued by flow number through the signal processing unit. After the MAC packets are edited into an IP packet, the IP packet is transferred to the destination application by the main control routine 400.

FIG. 12 shows an example of end-to-end communication sequence in the wireless communication network to which the invention is applied.

An application (APL) 30A outputs an IP packet for FTP (File Transfer Protocol) access addressed to a server 13A to the wireless terminal (AT) 40 (SQ101). Then, the AT 40 automatically sets up a session with a QoS suitable for FTP traffic in cooperation with the associated BTS/BSC. Through this session, the APL 30A starts FTP communication with the server 13A. After the elapse of a period T1, the APL 30A terminates the communication with the server 13A (SQ102).

Next, when an application (APL) 30B sends the AT 40 a packet for VoIP addressed to another terminal 40B which is omitted from FIG. 1, the AT 40 automatically sets up a session with a QoS suitable for VoIP traffic in cooperation with the BTS/BSC. Through this session, the APL 30B starts VoIP communication with the terminal 40B (SQ201). After the elapse of a period T2, the APL 30B terminates the communication with the terminal 40B (SQ202).

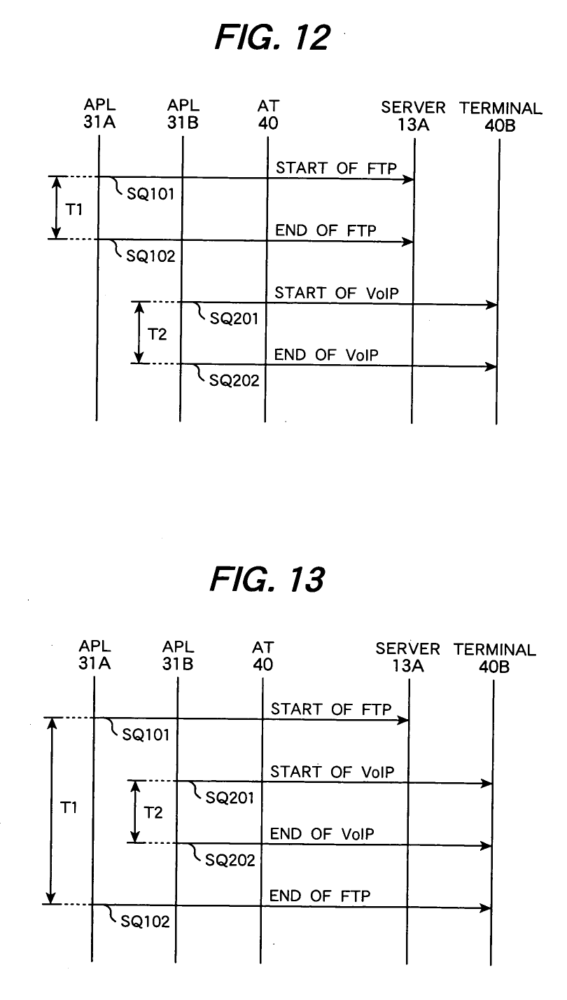

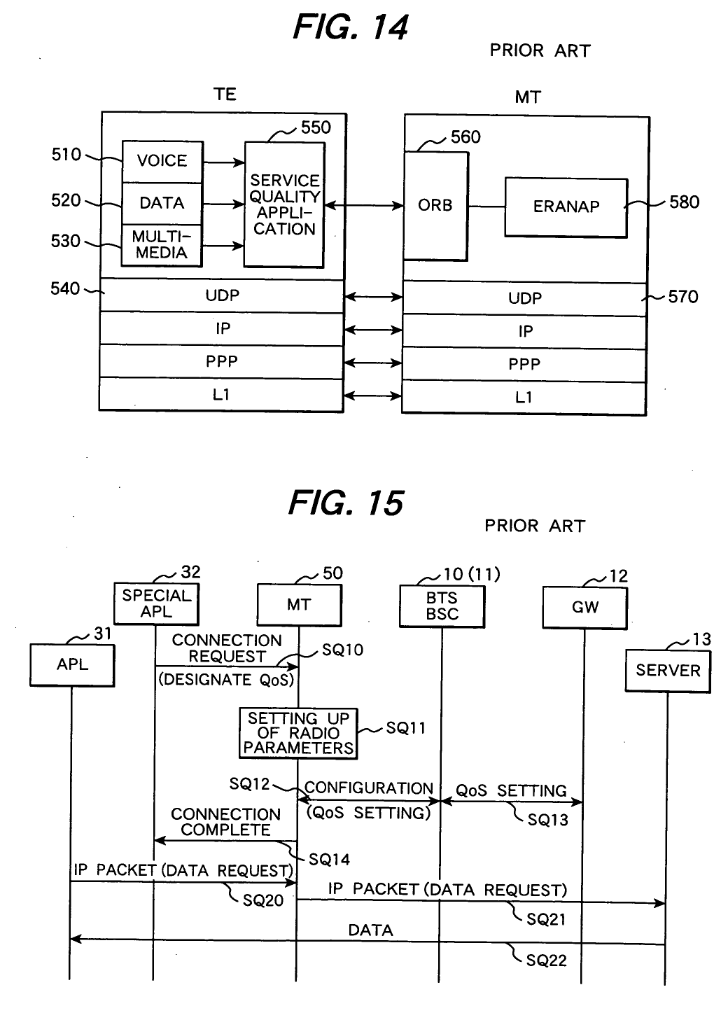

FIG. 13 shows another example of end-to-end communication sequence in the wireless communication network.

This sequence illustrates an instance where, during a period T1 of FTP communication being continued between the APL 30A and the server 13A, the APL 30B starts VoIP communication with the terminal 40B (SQ201) and terminates the VoIP communication (SQ202). According to the invention, since the AT 40 automatically sets up a QoS appropriate for each application at the time of reception of the first packet from each of applications 30A and 30B, it is possible to set up a plurality of sessions with different QoS levels during the same time period, as illustrated by this example.

Although the QoS type table 470 and the radio parameter table 480 are prepared in the wireless terminal (AT) 40 as separate ones in the foregoing embodiments, these tables may be integrated into a single conversion table. That is, in the QoS type table 470, the radio parameter set 482 shown in FIG. 8 may be registered instead of the QoS type 474. Thereby, it would be possible to search for both a session setup flag 475 and a radio parameter set 482 at a time with a search key of the destination IP address and the destination port number of a received packet. It may be possible to download the contents of these tables and the QoS processing routine 410 using the tables from a specific server connected to the Internet network 20 to each wireless terminal.

What is claimed is:

1. An wireless communication apparatus for communicating with one of wireless base stations forming a wireless communication network, the wireless communication apparatus comprising:
a conversion table including a plurality of entries, each defining a set of radio parameters for assuring a Quality of Service (QoS) in association with the value of at least one header item of an IP packet; and
a controller for searching said conversion table based on header information of an IP packet issued from an application, for a set of radio parameters appropriate to the received packet, and executing a specific communication procedure for setting up a new session between the apparatus and its associated base station based on the set of radio parameters,
wherein a QoS required by said application is assured on said session.

2. The wireless communication apparatus according to claim 1, wherein
each entry of said conversion table includes a flag indicating whether a session has been set up, and if the flag in an entry corresponding to said received packet searched from said conversion table indicates that a session has not been set up, said controller executes said specific communication procedure for setting up a new session and changes the flag to a session setup done state.

3. The wireless communication apparatus according to claim 1, wherein
said conversion table is comprised of a QoS type table including a plurality of entries, each defining a QoS type number in association with the value of at least one header item of an IP packet, and a radio parameter table including a plurality of entries, each defining a set of radio parameters for assuring a QoS in association with the QoS type number.

4. The wireless communication apparatus according to claim 2, wherein
said conversion table is comprised of a QoS type table including a plurality of entries, each defining a QoS type number in association with the value of at least one header item of an IP packet, and a radio parameter table including a plurality of entries, each defining a set of radio parameters for assuring a QoS in association with the QoS type number.

5. The wireless communication apparatus according to claim 1, wherein
said application is executed on terminal equipment connected to the wireless communication apparatus and said IP packet is received from the terminal equipment.

6. The wireless communication apparatus according to claim 2, wherein
said application is executed on terminal equipment connected to the wireless communication apparatus and said IP packet is received from the terminal equipment.

7. The wireless communication apparatus according to claim 3, wherein
said application is executed on terminal equipment connected to the wireless communication apparatus and said IP packet is received from the terminal equipment.

8. A method of setting up a Quality of Service in a wireless communication network including a wireless communication apparatus and wireless base stations connected to an Internet network via a base station controller, the method comprising:
a step of searching, by said wireless communication apparatus based on header information of an IP packet issued from an application, a conversion table having been prepared beforehand for a set of radio parameters for assuring a Quality of Service (QoS) appropriate to the received packet; and
a step of executing a specific communication procedure for setting up a new session between said wireless communication apparatus and its associated base station based on the retrieved set of radio parameters searched from said conversion table.
